(19) United States
(12) Patent Application Publication
(10) Pub. No.: US 2012/0154310 A1
(43) Pub. Date: Jun. 21, 2012

(54) Interactive Multimedia Advertising System

(76) Inventors: Joseph Denny, Vancouver (CA); Borislav Trifonov, Vancouver (CA); Sara Perjalian, Vancouver (CA)

(21) Appl. No.: 13/320,269

(22) PCT Filed: May 13, 2010
(86) PCT No.: PCT/CA10/00718

§ 371 Date: Mar. 2, 2012

(51) Int. Cl. G06F 3/041; G06F 15/16

(52) U.S. Cl. 345/173; 709/203

(57) ABSTRACT

An interactive multimedia advertising system is disclosed. The system comprising: a plurality of interactive advertising kiosks that are deployed over a secure network; a centralized server in communications with each of the plurality of advertising kiosks; means for controlling and monitoring each advertising kiosks; means for managing multiple content modules on each kiosk via an application programming interface and a software development kit; a plurality of client, operator and manager interfaces; and means for producing in-house and client-created content. Each kiosk comprising a central processing unit; a display window having a recessed touchscreen optic; a camera; a microphone; a speaker; a plurality of communications means, wherein the central processing unit is operable to download content from the central server, to display the downloaded content, to mediate interaction between the kiosk and a consumers' touch, voice and other inputs, and to compile and send feedback and performance information to the central server.

Crissy Field Media Inc. (CFM), in moving towards its goal to be the leader in digital out of home advertising, has created proprietary technology to enable geographically distributed interactive multimedia advertising based on large format touchscreen displays and high fidelity that are all part of a flexible networked system, Live Interactive Media Advertising Network System (LIMANS). The preferred embodiment of LIMANS consists of:
LIMANS consists of several components, described in more detail below:
fleet of interactive advertising kiosks (AD PODs);
secure networked deployment, control, and monitoring;
centralized servers;
client and CFM operator interfaces;
a software architecture (Core) for running and managing multiple content modules on each AD POD;
an application programming interface (API) and software development kit (SDK) for content modules; and,
a production process for in-house content, as well as a quality assurance process for client-created content.

FIG. 1 shows a high level view.

AD POD

The AD POD is a large multi-screen, multi-touch kiosk supporting interactive advertising and other media content, and real-time reporting of interactions and control of the content. Each AD POD contains multi-core compute nodes running the proprietary AD POD Core software and content modules, such as touch-based activity content that allow consumers to interact with virtual products, interactive directories and maps, video streaming, Bluetooth push content, VOIP calls, Web content, or any media. The compute nodes drive large format screens and can communicate with the other nodes in the AD POD to be able to present a unified virtual world on multiple screens. The AD POD contains redundant systems and safeguards to ensure high reliability and virtually eliminate downtime. The advantage of the interactive presentation is that it keeps consumers interested in the full duration of the advertisements and gets them to return to “play again”.

Network

The fleet of installed AD PODs is controlled by CFM servers, which
deploy advertising or other media content modules and software updates;
send scheduling information and module parameters to the AD PODs; and,
send any control information such as shutdown commands or adjustments of operating parameters.

When new content is to be presented on given AD POD screens, the software component of a module and associated data files are securely distributed to given AD PODs over an encrypted protocol, along with the updated schedule of running those modules, and any parameters such as which screens should display the module, which versions of certain media files to use during specific times of day, and so on.

In addition, the AD PODs provide frequent periodic communication to the CFM servers that includes the following:
heartbeat signal to indicate the unit is operating nominally and has not crashed or become disconnected;
operational logs of system health and other internally generated events;
logs of user interactions that can be used for marketing data mining; and,
alarms on critical software failures, structural breaches, or hardware problems.

The advantages of the networked aspect of LIMANS is online distribution of advertising and other content that allows advertising campaigns to be tuned, and real-time monitoring of interactions.

Operator Interface

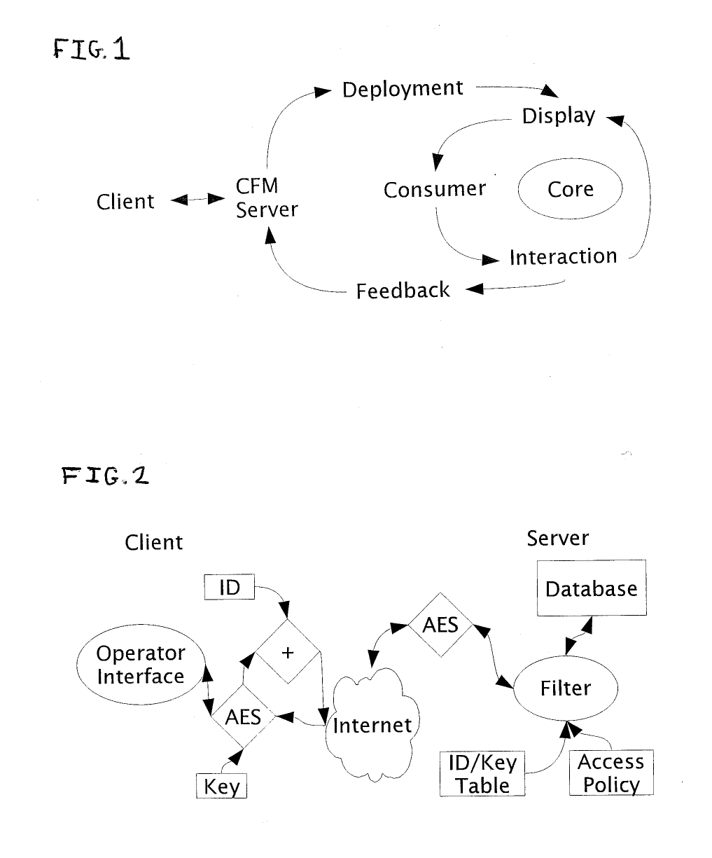

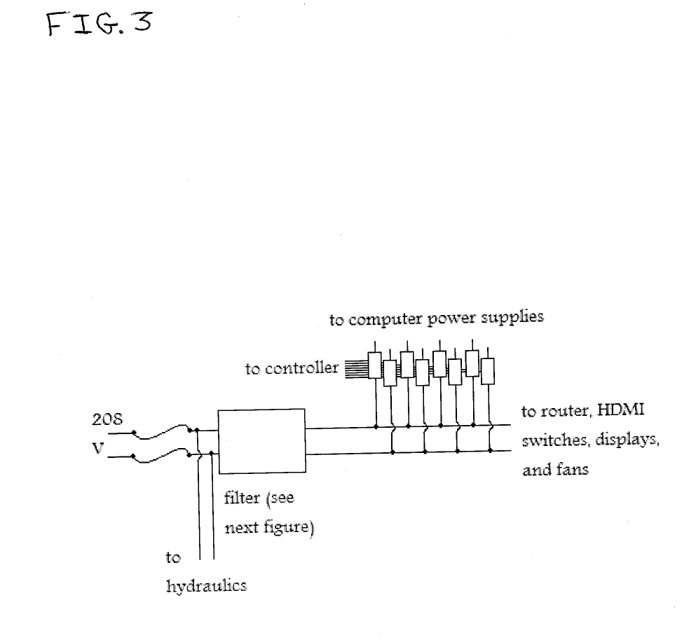

CFM and clients are provided appropriate levels of control by a scheduling and control interface which connects to the CFM servers. The interface receives scheduling and status data from the servers, and presents it to operators in user-friendly visual formats, allowing them to adjust the scheduling of content to different subsets of AD PODs along with specific dates, times, and screens, add new content to the system to be deployed, and send commands to the AD PODs. The operator interface securely sends the servers any updates, which are then filtered based on a policy specifying the privileges of different operators, so that clients may only modify their own content. Immediate commands are passed on to the AD PODs, whereas scheduling changes are entered into the server database, and content is forwarded to a quality assurance (QA) process. This is shown in FIG. 2.

Software Architecture

The AD POD Core is the software that runs on AD POD compute nodes and manages all aspects of the AD POD, including
coordination of multithreaded operation and data sharing between Core components and multiple concurrent content modules;
networked communication with the CFM servers to receive modules, scheduling and other information;
logging operational status and user interactions;
monitoring system health and initiating failsafe processes when necessary;
managing scheduling and loading and unloading of content modules; and,
managing resource sharing by content modules, including the use of sound, graphics co-processors, processing of user interactions, and compositing multiple contents on the screens.

The modules and core interact through an API designed to aid the production process since the interface to which every module must conform is well defined. This also allows some automation of the QA process, and the distribution of an SDK to clients so that they may create their own content, which CFM will then check for conformance to specifications.

Brief

Computerized system controlling interactive advertising kiosks connected to a network with a centralized controller (whereby “controller” is not to necessarily designated a single system but may consist of e.g., without loss of generality, a set of servers) that specifies which advertisements are displayed at which time on each of the geographically distributed physical screens, and an operators' interface to the centralized controller.

1. Each of one or more screens is connected to a controlling local computer and is paired with a touchscreen or other touch-based input to form one side of an advertising and/or media kiosk placed in a public location for interaction with by a member or members of the public.

2. The local computer sends to the display advertisements and other media content which can consist of still images, animated images, computed images, and/or interactive images produced through interaction with a user or users.

3. The user or users interact with the local computer through the touch screen, camera, voice, or phone or other personal wireless device.

4. The local computer processes the inputs from the input devices and computes new images presented in quick succession to produce the experience of interactive control of the image.

5. The local computer receives from the centralized system over the network, such as the Internet, the schedule of advertising and/or media display.

6. The local computer receives from the centralized system advertisements in the form of software modules to be executed on the local computer using its processing hardware and software.

7. The local computer requests from any other computer on the network additional content downloaded from the Internet as specified by the centralized system or by the advertisement when executed.

8. The local computer sends to centralized system record of interaction logs and operational logs and alerts for further processing and analysis.

9. The centralized system notifies CFM operators of received alerts.

10. The local computer receives from the centralized system live control data that may change its operating parameters.

11. The centralized system may send out stored scheduling and control information, such as from a database, or permit live control by an operator.

12. The centralized system sends stored scheduling data and/or logs and metrics received from the kiosks to operators' scheduling and control interfaces, where the operators may be CFM agents of agents of CFM's clients.

13. The scheduling and control interface may run on a computer local to the centralized system, or over a network such as the Internet, and it may be Web-based.

14. The scheduling and control interface made available to CFM and clients may be configured in different versions with varying features.

15. The operator views the data sent from the centralized system, and may update the schedule and other kiosk operating parameters, and the scheduling and control interface sends the updates to the centralized system.

16. The scheduling system is able to present the data in various views e.g., without loss of generality, as a visual timeline and/or table, for one or multiple kiosks.

17. The network transmission to the centralized system is encrypted and digitally signed by the client to guarantee that the updates indeed come from the client.

18. The centralized system filters the received schedule and control updates based on a policy assigned to the particular client before committing it to its data store and/or sending it out to the kiosks.

19. The scheduling and control interface and the centralized system have error and consistency checking.

20. Clients are provided a software development kit for producing content modules.

21. Content modules are submitted to CFM and go through a quality assurance process, which may be automated, before being entered into the centralized system for distribution to the kiosks.

Multimedia Kiosk

Crissy Field Media Inc.'s (CFM) AD POD, in its several preferred embodiments, is an interactive advertising kiosk designed to be standalone and require only connection to a power outlet, and a wireless Internet router within range. It's intended to be rugged, appear autonomous, and handle various failure modes, while having the flexibility of installation in various indoor and outdoor locations. Several screens and multi-touch support allows presentation of interactive content to several consumers simultaneously. The images below show the AD POD Tri, AD POD Quad, and AD POD 360.

To achieve the design goal of sturdiness, an internal metal frame adds weight and stability, and a tough fiberglass-backed plastic shell protects the insides, and Lexan windows protect the displays. Such a construction is highly resistant to vandalism. Suction cups on the bottoms, with vacuum maintained by a pump, ensure the AD POD is not moved. A vinyl wrap applied to the shell can provide additional protection, being easily replaceable, and be also used for further advertising by being printed with images. The frame and internals can be exposed by pneumatic telescoping cylinders lifting the shell, giving easy access for servicing. Only partially lifting the shell allows a palate jack or forklift to lift the kiosk. If the lifting mechanism fails, the internals can be accessed by unlocking and removing the top cover of the shell. The shell would either intake cool air from the bottom and exhaust it through the top, or use a compressor-based cooling system with a radiator at the top. The intake and exhaust ports have splash guards protecting the AD POD from liquid entry such as from a spilled drink or a vandal with a water pistol.

While the windows are mounted to the shell with adjustable attachment aids, along with the recessed touchscreen optics, and cameras, microphones, and speakers, the displays are preferably mounted to the frame, on mechanisms allowing them to swing open like a door, and thus the components in the center of the kiosk can be accessed. These components include the computers driving the screens, wireless router connecting the AD POD to the CFM servers and/or other AD PODs, power supplies, Bluetooth devices for pushing content to nearby mobile devices, backup computers and switches that connect them when operating computers fail, cooling systems, various sensors that monitor operation of the kiosk, and an automatic fire extinguisher.

Brief

Interactive advertising kiosk consisting of multiple touchscreen displays, internal compute nodes with wireless network connection, an internal framework, outer shell, and mechanisms for exposing the internals.

1. Kiosk with two, three, four, or more touchscreen displays.

2. Displays are one touch or multi-touch.

3. Displays are flat or curved.

4. Configurations include, but are not limited to a

a) three-sided configuration with three flat displays, in the shape of an upright equilateral triangular prism with rounded edges, with one display per side;

b) four-sided configuration with four flat displays, in the shape of a box with rounded edges; and,

c) curved configuration with a continuous display around the whole unit, in the shape of a cylinder, with a capping structure.

5. External shell from ABS, acrylic, or other plastic.

6. Shell may be backed by fiberglass or carbon fiber for strength.

7. Shell may be uncoated, or coated with paint or other material, such as scratch resistant compounds.

8. Shell may be wrapped with vinyl on which images have been printed.

9. Shell has borosilicate glass or strong plastic such as polycarbonate windows to protect the displays.

10. Shell is attached to an internal frame made of steel or aluminum.

11. Shell attachment is not fixed but may be moved.

12. Shell attachment may use rubber grommets to decrease mechanical shock transfer to the internals.

13. Shell movement relative to frame is restricted by means of mechanical or electronic locks.

14. Shell movement relative to frame may be manual or powered by means such as pneumatic, hydraulic, or motor.

15. Shell movement relative to frame may be powered both by an internal pump or motor, or an external pressurized fluid supply.

16. Touchscreen displays may be attached to shell or frame, or the touchscreen attached to shell and displays attached to frame.

17. Adjustable touchscreen display attachment.

18. Compute nodes inside the shell driving the touchscreen displays, with one or more redundant compute nodes as backup.

19. Compute node to display connections may be reassigned by a switching device inside the shell.

20. The compute nodes have a wireless networking device or devices.

21. Bluetooth devices, cameras, microphone, and/or speakers connected to the compute nodes.

22. The compute nodes are cooled by air (heatsinks, heat pipes, and/or fans), or liquid cooling.

23. The shell may contain fans and inlet and exhaust ports to provide cooling airflow.

24. Shell openings are protected by splash guards designed for blocking liquid streams and drainage onto the ground.

25. Compressor-based cooling with an external radiator may be used.

26. Compute nodes may be directly connected to the compressor-based cooling system, or through a heat exchanger or the air inside the shell.

27. Compute nodes or a microcontroller monitors sensors which may include the status of internal electronics, physical interlocks, temperatures at various locations, airflow, liquid flow, power usage, and power supply voltages.

28. Compute nodes or microcontroller may activate or adjust electronics or actuators such as the display switch, fans, or the power of other compute nodes.

29. Fuses and thermal fuses may be used for protection from electrical failure or overheating.

30. A fire or smoke activated extinguisher may be used for protection.

31. Kiosk may be affixed to a smooth ground by means of powered suction cups.

Electrical Design

The overview of the electrical system is shown in the first page of the attachments. Power connections are shown in red, data in blue, and sensor/control in green. The sections below correspond to the numbered sections of that drawing.

Power Distribution

A feed of 208 V from the left first goes through thermal fuses that will cut power in case of severe overheating, and a breaker/filter circuit, then is distributed by direct connections to the router, HDMI switches, LCD displays, and fans. The power lines to the hydraulics or screw lift system motor can be connected before the filter (it is recommended that the hydraulics are be controlled independently of the computer and controller board system so that it can be activated even in a complete failure of the electronics). The power lines to the computers are switched by relays which get their drive (green) from the controller board (additional relays can be used for the displays). The computer and LCD screen internal power supply units are expected to work on 208 V without modification, but the fans, HDMI switches, and router may need basic converters (inexpensive due to the low power drawn).

The thermal fuses reset themselves after cooling and don't have other failure modes. Strong relays do not fail for long periods. No backup is practical for this section; solid wiring is the most important to robustness. See FIG. 3.

Power Filter

The filter and protection circuit consists of an over-current resettable breaker, gas arrestor tube to protect the MOV from high voltage spikes, a MOV to clean up medium spikes, and a capacitor/common-mode choke EMI filter (this can be either assembled or purchased as a packaged part).

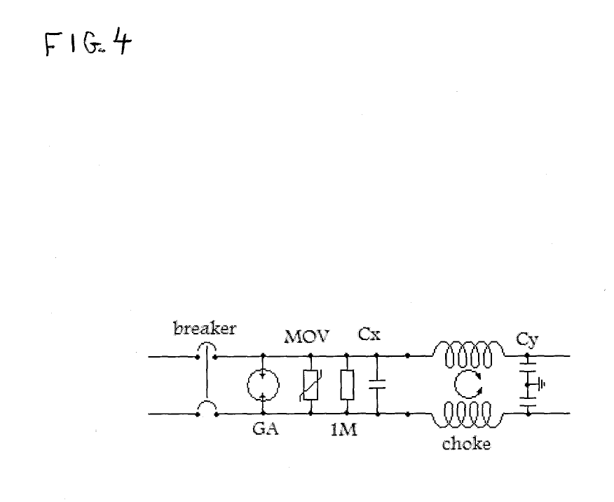

The breaker can be self-resetting; the gas arrestor will fail after sufficient high voltage spikes (which should be a rare occurrence), and a second one may be put in parallel to extend its life; the same applies to the MOV. If the gas arrestor or MOV fail, the circuit will continue to function and the protection circuits in the power supplies of the electronics will be the second line of protection. The CX and CY capacitors and a choke of sufficient current rating have very long lifetimes. No backup is practical for this section; simple redundancy of the gas arrestor and MOV is sufficient. See FIG. 4.

Controller Board

Temperature sensors, current sensors from the fans, and USB data from the computers are used by the controller board (schematics of which compose the attachments to this document), which acts as an interface between the core software (through a driver) and the controllable entities. Those outputs drive the relays controlling power to each computer (and also monitors if they're to be switched on/off), the HDMI switch triggers that reassign computers to displays, and USB control information sent to computers. This design provides flexibility for expansion (it's simple to connect new sensors and relays) as well as process policies for dealing with error situations, as those are simply written into the core software. Those policies should be based on the previously done Contingencies report.

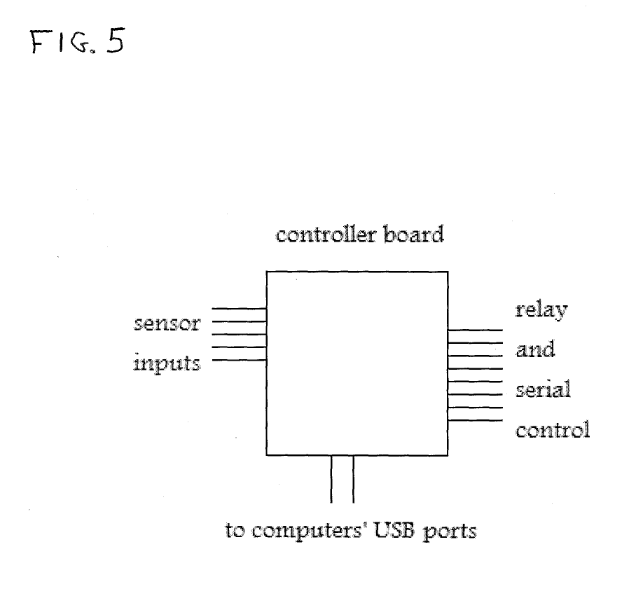

The controller board is the most complicated section and it may be beneficial to have a backup board. However, at this stage this is a significant complication since a large number of connections would have to be switched. It is still much less likely to fail than one of the computers or other electronics in the AD POD. See FIG. 5.

Video Connections

Each of the HDMI switches is modified to receive an electrical control signal (green) instead of a button press to switch, and is directed by the controller board to bridge the video signal (blue) from one of the four computers to the LCD screen it's connected to.

The displays cannot be backed up. The main backup is the redundant computer system, and much of this circuitry is there to enable the use of that backup system. The HDMI switches are simple with just a few integrated circuits, and are less likely to fail than the controller board. Backing up the switch system means duplicating it, and is not practical due to the expense. The most important issue is securing the connections.

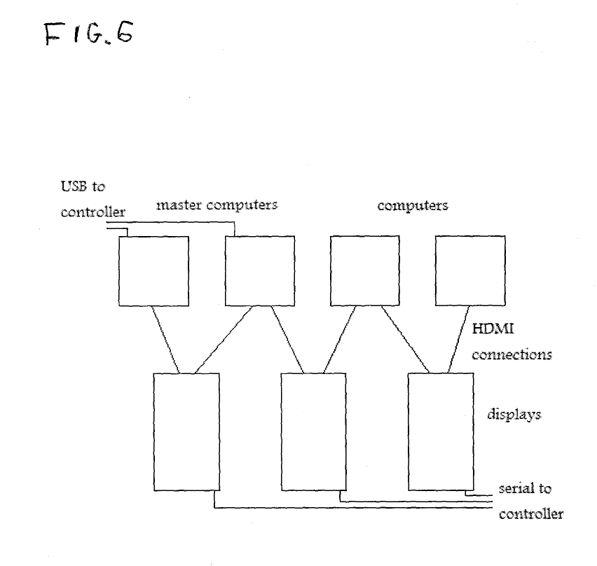

In the case of the router, it can also be backed up, but the wiring and control is more complicated. The controller board should be able to reset power to the router. See FIG. 6.

Cooling

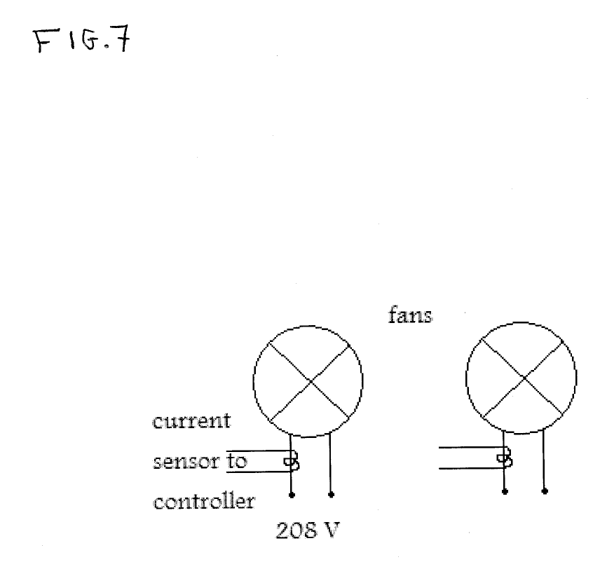

Common 240 V fans may be used and the lower voltage will run them at a lower speed. A single fan should provide sufficient cooling air flow in case one malfunctions. Basic current sensors allow the controller board (3) to make sure a fan is operating (drawing power). In a possible enhancement, fans with speed control may be used and adjusted by the controller board based on temperature. See FIG. 7.

Software System for Interactive Media

In order to implement the AD POD interactive advertising kiosk software, Crissy Field Media Inc. (CFM) has developed a proprietary solution (the core), responsible for downloading content modules from the CFM servers, loading and displaying the advertising and other content modules, mediating interaction between the active modules and consumer (through inputs such as touch and voice), and sending interaction feedback and performance information back to the CFM servers in real-time.

Content modules are the software and media data composing interactive advertisements and other interactive media packages to be displayed on the screens of an AD POD. A preferred embodiment of the core and modules integrating to form the AD POD software is shown in the figure below. All of State Control functionality (which in essence handles the logic of the interaction), and portions of Graphics, Physics and Animation, and Local Files comprise each module; the other ovals are software modules that provide the core functionality.

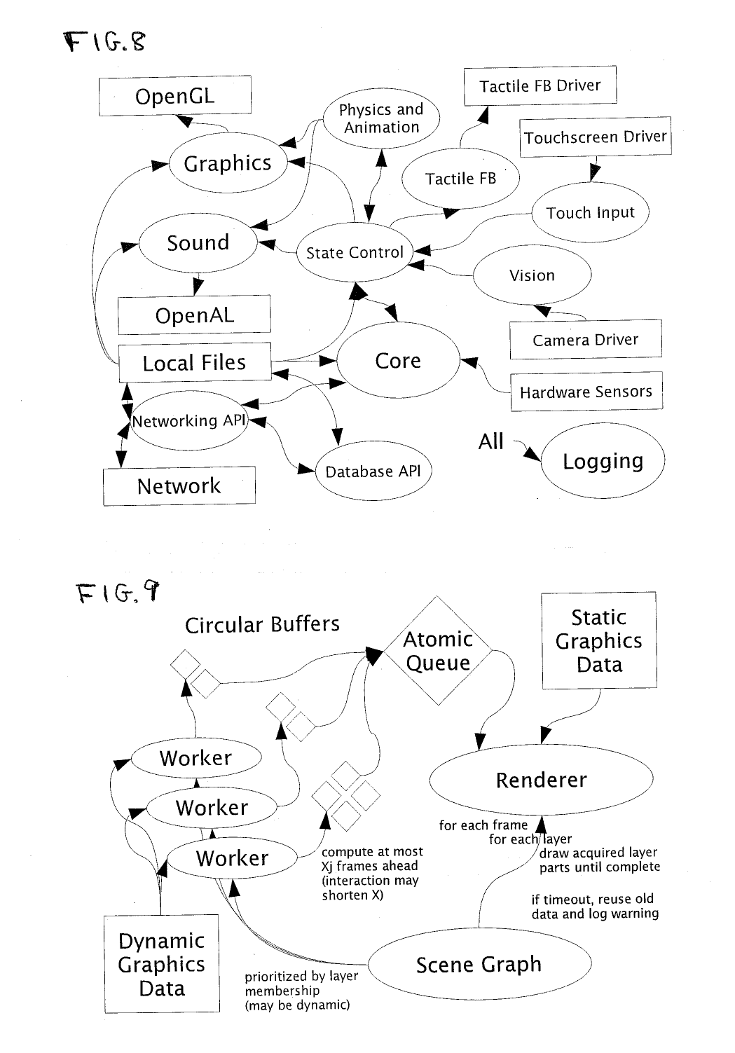

The core and module architecture has the advantages that it leverages existing technologies including computational node platforms, GPU co-processors, open-source software libraries, VOIP technology for telephone calls from the AD PODs, AES encryption of data transmitted over LIMANS, and high speed networking. Maximizing the use of the compute node resources allow commodity hardware to be used to lower the cost of AD PODs. See FIG. 8.

Core

The core manages the overall operation of the AD POD. It is multithreaded software consisting of a number of components:
scheduler and operational control (designated as Core in the figure above), which executes the software of content modules based on a schedule, serializes the GPU accessing routines of the modules in a single thread, and times module loading, initialization, state resetting, and unloading, as well as threads these appropriately, in order to satisfy the conditions that a module should be loaded and initialized in time for its scheduled period of activity, and unloaded to free memory, while minimally affecting the performance of any active modules;
watchdog, which monitors that content modules and core subsystems are responsive and not “frozen”, and that hardware sensors provide readings within acceptable ranges, and takes appropriate action such as termination or restart and sending an alert to CFM servers;
logger, which consolidates operational status from the various components, as well as interaction data, together with descriptive information about the threads and source code context of any log action, and periodically saves and sends the thresholded log data to CFM servers;
network subsystem, which handles communication with the CFM servers and other AD PODs, along with encryption, and manages both live communication such as commands and streaming data, as well as uploading of new files;
input subsystem, which processes touch input and redirects it to the appropriate active content modules; and,
optional subsystems, which may not be used by every content module, and include managed for module sharing interfaces to speakers, microphone, VOIP call, camera, and tactile feedback hardware.

Modules

The module architecture enables novel, high fidelity, visually compelling advertisements including realistic 3D graphics, and containing physical interactions such as interactive simulations of
fluids;
cloth;
fog, smoke, rain, and fire;
rigid and soft body dynamics; and,
hair and fur.

These features induce consumers to interact with the advertisement and product. This is aided by the use of intuitive multi-touch gesture-based interactions designed to be easily discovered by exploratory interactions, thus drawing in the consumer into engaging the content with increased interest and for a longer duration.

The API for individual content modules supports the dynamic loading, unloading, and display of the content. Modules can utilize almost all of the resources of the host compute node, including networking, multi-core CPUs, and GPU co-processors, based on the lock-free, low overhead multithreaded data sharing presented in the figure below. The API specifies how the module is loaded, initialized, when it launches its processing threads, how it receives interaction events, and how its graphics routines are organized for compatibility with other modules that may draw to the screen. The API also allows modules to utilize other functionalities of the core, including VOIP calls, Bluetooth access, video streaming, and access to remote databases, as well as feeding back information for logging by the core, such as performance metrics. It also allows for partial automation of the quality assurance process for content produced by clients (with the help of an SDK provided by CFM) by checking that it conforms to the API and additional operational invariants CFM may specify. See FIG. 9.

Multi-Touch

As the consumers interacting with the AD POD are essentially untrained, though potentially sophisticated, reliance on a specific set of gestures such as a pinch for zoom is not relied upon; instead, direct manipulation is utilized as much as possible, and touches are categorized contextually into selections, pushes, and navigations. Derived quantities such as velocities and forces can be computed from the touch positions to aid interaction with the virtual world of a content.

Brief

Computerized system for display of interactive media content, including but not limited to, advertisements, on a flat or curved display incorporating a touch-based interface, and an architecture for processing interactions with interactive multimedia content, advertisements, wherein the advertisements or other media are software modules together with associated media data executed by a larger system which coordinates the display and input signals. The computer system processes the touches and produces new images in manner which creates the illusion of control of the content.

1. Computer with central processing unit, persistent storage such as hard disk drive, random access memory, graphics processor with highly parallelized data processing architecture, and network interface.

2. Flat or curved display such as LCD or plasma panel or rear projection screen which displays images computed by the computer.

3. Touchscreen surface or sensors which detect touches and communicate them to the computer.

4. Software executing on the computer which processes the touches by categorization based on context and computation of derived quantities, and communicates the results to loaded advertising or other media content modules.

5. Advertising or other media modules which compute the image to display and the modifications to the image based on the received touches. Modules also include media data such as images, video, and sound, which can be displayed. Additionally, modules can receive from other computers on the network different data to be displayed, including but not limited to weather, time, and news headlines.

6. Multiple content modules can run concurrently, and images they generate are composited on the screen, while resources are shared.

7. Media scheduler which, using a table of advertising and other media schedule, determines when each content module should be loaded, initialized, displayed, and unloaded.

8. Network module which communicates with a centralized computer to receive the advertising schedule (data), and transmit operational and interaction logs.

9. Heartbeat module which reviews internals data structures and operational variables to determine if the software systems in #4 is operating correctly. If yes, it sends out a signal on the network to peer computers which could be connected to the display.

10. Multithreaded architecture for the software modules which allows multiple hardware processing cores to process inputs and outputs without waiting for other modules to cooperatively share the processing cores.

11. Software modules for communicating with additional hardware devices such as video and still cameras, microphones, speakers.

12. Software modules for communicating with additional software modules such as the underlying operating system, telecommunication encoders and decoders, video display systems, etc.

13. Software modules for communicating with other computers in the kiosk cluster or remote screens for the purpose of seamless advertisements where neighboring screens are joined or overlapped in a seamless manner.

14. Software module for communicating the current state of the currently running advertising modules to a backup computer which can replace the computer in case of failure.

15. Each of the interactive content modules contains three elements:

a) an internal model specifying the state of the advertisement and its elements;

b) a view model specifying the appearance of the advertisement for display on a display device computed from model (a); and,

c) a control module that translates interactions into modifications of model (a).

16. The host software system communicates to the scheduled active content modules signals to load required data from persistent storage or from other computer systems on the network.

17. The host software system signals the content modules to perform initialization processing which prepares the internal model and hardware registers on the computer for the display of the view models.

18. The host software system signals the content modules to start updating their internal models.

19. The host software system signals the content modules with interaction data from the touch screen, video camera, or microphone.

20. The host software system receives from the content modules requests to send data to other software modules such a phone conferencing system, another display system, or other computer system or computer peripheral.

21. The host software system signals the content modules to update the view models to the display.

22. The host software system signals the content modules that the interaction has ended by detecting the departure of the user, or observing that since the last interaction more seconds elapsed than a specified threshold.

23. The host software signals the content modules to stop updating their internal models.

24. The host software signals the content modules to unload their data from the memory and computer system.

25. The content modules have separate routines which can be run concurrently, and routines, such as those that access the GPU, that must be serialized, and the host software runs them correspondingly.

26. The graphics subsystem shares dynamic data with the animation and physical simulation subsystems via lock-free data structures for optimal performance and avoiding deadlocks and other problems of locking synchronization.

27. Animation and simulation computations may be prioritized e.g., including but not limited to, visual importance, so that responsiveness and fidelity is maximized for certain interactions and effects.

28. The dynamic data to be displayed is computed and buffered for one or more frames ahead, depending on parameters e.g., including but not limited to, time since last user input.

29. Some precomputed data may be invalidated by user interaction, forcing their re-computation, for the visuals to be consistent with the interaction.

1. An interactive multimedia networked advertising system comprising:
a plurality of interactive advertising kiosks;
secure networked deployment, control and monitoring;
one or more centralized servers;
at least one client interface;
at least one operator interface;
a software architecture for running and managing multiple content modules on each kiosk; and
a production process for operator-produced and client-produced content.

2. An interactive multimedia kiosk comprising:
a plurality of touch screen displays;
an external removable shell manufactured of ABS, acrylic, or other plastic and having borosilicate glass or strong plastic windows over the displays;
an internal metal frame;
locking means for restricting movement of the shell relative to the frame;
computers inside the shell to operate the displays;
wireless networking means;
kiosk cooling means;
splash protection means;
monitoring means for monitoring status of electronics, locking means, temperatures, airflow, liquid flow, power usage and power supply voltages; and
means for reversible attachment of the kiosk to a support surface.

3. The kiosk of claim 2, wherein the displays are flat.

4. The kiosk of claim 2, wherein the displays are curved.

5. The kiosk of claim 2, wherein the kiosk has the shape of an upright equilateral triangular prism with one display on each of the three vertical sides.

6. The kiosk of claim 2, wherein the kiosk has the shape of a box with one display on each of the four vertical sides.

7. The kiosk of claim 2, wherein the kiosk has the shape of a circular cylinder, with a continuous curved display surrounding the kiosk.

8. The kiosk of claim 2, wherein the shell is reinforced with a material selected from the group comprising fibreglass and carbon fibber.

9. The kiosk of claim 2, wherein the shell further comprises an external coating.

10. The kiosk of claim 2, wherein the shell is manufactured of a material selected from the group comprising steel or aluminum.

11. The kiosk of claim 2, further comprising shock absorbing means, wherein the shock absorbing means may be pneumatic, hydraulic or motorized, and are powered by an internal pump or motor, or an external pressurized fluid supply.

12. The kiosk of claim 2, further comprising at least one redundant computer for backup.

13. The kiosk of claim 2, further comprising one or more Bluetooth devices connected to the computer.

14. The kiosk of claim 2, further comprising one or more cameras connected to the computer.

15. The kiosk of claim 2, further comprising one or more microphones connected to the computer.

16. The kiosk of claim 2, further comprising one or more speakers connected to the computer.

17. The kiosk of claim 2, wherein the shell further comprises an air cooling system selected from the group of air cooling systems comprising heat sinks, heat pipes and fans.

18. The kiosk of claim 2, wherein the attachment means comprises suction cups.

19. A computerized system for display of interactive media content, comprising:
a computer with a central processing unit, persistent storage such as a hard disk drive, random access memory, graphics processor with highly parallelized data processing architecture, and network interface;
one or more display screens to display images computed by the computer;
a plurality of touch screen surfaces which detect touches and transmit them to the computer;
touch processing software which processes touches by categorization based on context and computation of derived quantities, and communicates the results to media content modules;
media modules which compute the image to display and any modifications to the image based on received touches, including images, video and sound; wherein multiple content modules may run concurrently with shared resources;
a media scheduler to determine when each content module should be loaded, initialized, displayed, and unloaded;
a network module to communicate with a centralized computer to receive data schedules and transmit operational and interaction logs;
a review module to review internal data structures and operational variables;
a multithreaded architecture for the software modules to allow multiple hardware processing cores to process inputs and outputs without waiting for other modules;
software modules for communicating with peripheral devices such as cameras, microphones and speakers;
software modules for communicating with the underlying operating system, telecommunications encoders and decoders, and video display systems;
software modules for communicating with other computers in other networked kiosks or remote screens for display of seamless media over multiple screens; and
a software module for communicating the status of the operating computer to the backup computer.
